(19) United States
(12) Patent Application Publication
(10) Pub. No.: US 2011/0102202 A1
(43) Pub. Date: May 5, 2011

(54) TRAFFIC CONTROL SYSTEM AND METHOD USING POSITIONED DATA

(75) Inventor: Chih-Yin Lin, Tao Yuan Shien (TW)

(73) Assignee: QUANTA COMPUTER, INC., Tao Yuan Shien (TW)

(21) Appl. No.: 12/834,938

(22) Filed: Jul. 13, 2010

(30) Foreign Application Priority Data
Oct. 30, 2009 (TW) 098136827

(51) Int. Cl. G08G 1/123

(52) U.S. Cl. 340/988

(57) ABSTRACT

The invention provides a traffic control system and method. In particular, the traffic control system and method according to the invention utilizes GPS, AGPS, GLONSS, Galileo global navigation satellite system, and so on to generate and transmit a preemption request signal for an emergency vehicle, such as ambulance, etc. At a designated traffic signal, the preemption request signal is received and filtered to get designated data associated with the designated traffic signal. Afterward, if the designated signal is judged to be valid, a state change request data is selectively generated according to the designated data, and the designated traffic signal is controlled based on the state change request data.

### BACKGROUND OF THE INVENTION

1. Field of the Invention

The invention relates to a traffic control system and method, and in particular, to a traffic control system and method for assisting emergency vehicles (such as ambulances etc.) in preemption by use of a positioning system.

2. Description of the Prior Art

It has the best convention for dealing with emergencies in modern society. For example, people dial to the emergency call center, such as 911 call center. Therefore, it will lead the appropriate medical and security teams to help. This process is already very mature, but sometimes, life and fortune are still damaged, or even caused damage by the emergency vehicles (such as ambulances, fire trucks, and police cars) got stuck in traffic. As we all know the reason why the emergency vehicles delay is bad traffic condition. As a result, when an emergency happens, the emergency vehicles will need to help rapidly pass through the heavy traffic, and quickly arrive at the destination.

Accordingly, one aspect of the invention is to provide a traffic control system and method which enable the emergency vehicle can actively and automatically trigger the next traffic lights on the way, the emergency vehicle will pass through, to light up the green light in the most accurate time, and such that the emergency vehicle then can be allowed to quickly pass through in the minimum disruption of traffic situation.

In addition, another aspect of the invention is to provide a traffic control system and method which enable the emergency vehicle to only notice the ordinary vehicles on the way, where the emergency vehicle will pass through, with precise position and speed of the emergency vehicle, the most accurate time when the ordinary vehicles should give way to the emergency vehicle, and other data relative to the emergency vehicle. Thereby, the emergency vehicle can go smoothly in the traffic. Besides, the ordinary vehicles can avoid not only blocking up the emergency vehicle but also having an accident, such as collision, with the emergency vehicle.

### SUMMARY OF THE INVENTION

A traffic control system according to a preferred embodiment of the invention includes an emergency vehicle unit and a traffic signal control unit. The emergency vehicle unit according to the invention relates to an emergency vehicle, and includes a first positioning module, a first storage module, a second storage module, a first navigation module, a radio signal transmitting module, and a first processing module. The first positioning module functions periodically acquiring current location coordinates associated with the emergency vehicle. The first storage module therein stores data associated with a plurality of traffic signals. The second storage module therein stores map data. The first navigation module is coupled to the first positioning module, the first storage module, and the second storage module, respectively. The first navigation module functions generating an emergency vehicle data and determining a plurality of designated traffic signals from the plurality of traffic signals in accordance with an emergency vehicle route relating to the emergency vehicle, the current location coordinates associated with the emergency vehicle, the data associated with the traffic signals, and the map data. The first processing module is coupled to the first storage module, the first navigation module, and the radio signal transmitting module, respectively. The first processing module functions generating, according to the emergency vehicle data and the plurality of designated traffic signals, a preemption request signal, and transmitting the preemption request signal through the radio signal transmitting module. According to the invention, the traffic signal control unit relates to one of the designated traffic signals, and includes a first radio signal receiving module, a first validation module, a state indication module, and a control module. The first validation module is coupled to the first radio signal receiving module. The first validation module functions receiving the preemption request signal through the first radio signal receiving module, and filtering a designated data associated with the designated traffic signal of the preemption request signal. The first validation module judges if the designated data is valid. The state indication module is coupled to the first validation module. If the first validation module judges the designated data to be valid, the state indication module receives the designated data, and selectively generates and transmits a state change request data in accordance with the designated data. The control module is coupled to the state indication module. The control module functions receiving the state change request data transmitted by the state indication module, and controlling the designated traffic signal based on the state change request data.

According to another preferred embodiment of the invention, the traffic control system further includes an ordinary vehicle unit. The ordinary vehicle unit according to the invention includes a second positioning module, a third storage module, a second navigation module, a second radio signal receiving module, a second validation module, and a second processing module. The second positioning module functions periodically acquiring current location coordinates associated with the ordinary vehicle. The third storage module therein stores the map data. The second navigation module is coupled to the second positioning module and the third storage module, respectively. The second navigation module functions generating an ordinary vehicle data in accordance with an ordinary vehicle route relating to the ordinary vehicle, the current location coordinates associated with the ordinary vehicle, and the map data. The second validation module is coupled to the second navigation module and the second radio signal receiving module, respectively. The second validation module functions receiving the preemption request signal through the first radio signal receiving module, and judging if the preemption request signal is valid. If the preemption request signal is judged to be valid, the second validation module judges if the ordinary vehicle route relating to the ordinary vehicle overlaps the emergency vehicle route relating to the emergency vehicle in accordance with the ordinary vehicle data and the preemption request signal. The second processing module is coupled to the second validation module. If the second validation module judges that the ordinary vehicle route relating to the ordinary vehicle overlaps the emergency vehicle route relating to the emergency vehicle, the second processing module receives and selectively generates a warning signal in accordance with the ordinary vehicle data and the preemption request signal.

A traffic control method according to a preferred embodiment of the invention, first, is at an emergency vehicle to perform the steps of: periodically acquiring current location coordinates associated with the emergency vehicle; generating an emergency vehicle data and determining a plurality of designated traffic signals from the plurality of traffic signals in accordance with an emergency vehicle route relating to the emergency vehicle, the current location coordinates associated with the emergency vehicle, data associated with the traffic signals, and map data; and generating and transmitting a preemption request signal in accordance with the emergency vehicle data and the plurality of designated traffic signals. And then, the traffic control method according to the invention is at one of the designated traffic signals from the plurality of designated traffic signals to perform the steps of: receiving the preemption request signal, and filtering a designated data associated with said one designated traffic signal from the preemption request signal; judging if the designated data is valid; and selectively generating a state change request data in accordance with said one designated data, and controlling said one designated traffic signal based on the state change request data if the designated data is judged to be valid.

According to another preferred embodiment of the invention, the traffic control method is further at an ordinary vehicle to perform the steps of: periodically acquiring current location coordinates associated with the ordinary vehicle; generating an ordinary vehicle data in accordance with an ordinary vehicle route relating to the ordinary vehicle, the current location coordinates associated with the ordinary vehicle, and the map data; receiving a preemption request signal, and judging if the preemption request signal is valid; if the preemption request signal is judged to be valid, judging if the ordinary vehicle route relating to the ordinary vehicle overlaps the emergency vehicle route relating to the emergency vehicle in accordance with the ordinary vehicle data and the preemption request signal; and selectively generating a warning signal in accordance with the ordinary vehicle data and the preemption request signal if the ordinary vehicle route relating to the ordinary vehicle overlaps the emergency vehicle route relating to the emergency vehicle.

In one embodiment, the current location coordinates associated with the emergency vehicle is acquired by receiving data transmitted from a global positioning system (GPS), an assisted global positioning system (AGPS), a global navigation satellite system (GLONASS), or a Galileo satellite navigation positioning system, etc.

In one embodiment, the preemption request signal includes an identity code relating to the emergency vehicle, the emergency vehicle route relating to the emergency vehicle, the current location coordinates associated with the emergency vehicle, a speed of the emergency vehicle, identity codes of the traffic signals been passed among the plurality of designated traffic signals, identity codes of the traffic signals not been passed yet among the plurality of designated traffic signals, state set requests for the traffic signals not been passed yet, an authorization check code, etc.

In one embodiment, the current location coordinates associated with the ordinary vehicle is acquired by receiving the data transmitted from the global positioning system (GPS), the assisted global positioning system (AGPS), the global navigation satellite system (GLONASS), or the Galileo satellite navigation positioning system, etc.

The advantage and spirit of the invention may be understood by the following recitations together with the appended drawings.

### BRIEF DESCRIPTION OF THE APPENDED DRAWINGS

FIG. 1 is a function block diagram of a traffic control system 1 according to a preferred embodiment of the invention.

FIG. 2 is a schematic diagram illustrating an environment where the traffic control system 1 according to the invention can be applied.

FIG. 3 is a flow diagram illustrating a traffic control method 4 according to a preferred embodiment of the invention.

### DETAILED DESCRIPTION OF THE INVENTION

The invention provides a traffic control system and method. And in particular, the traffic control system and method according to the invention utilizes a positioning system to assist the emergency vehicles, such as ambulance, fire truck, police car, and so on, in preemption. Thereby, the emergency vehicle can actively and automatically trigger the next traffic lights on the way, where the emergency vehicle will pass through, to light up the green light in the most accurate time, and then can be allowed to quickly pass through in the minimum disruption of traffic situation. And the emergency vehicle can notice the ordinary vehicles on the way the emergency vehicle will pass through, with precise position and speed of the emergency vehicle, the most accurate time when the ordinary vehicles should give way to the emergency vehicle, and other data relative to the emergency. Some preferred embodiments and practical applications of this present invention would be explained in the following paragraph, describing the characteristics, spirit, advantages of the invention, and feasibility of embodiment.

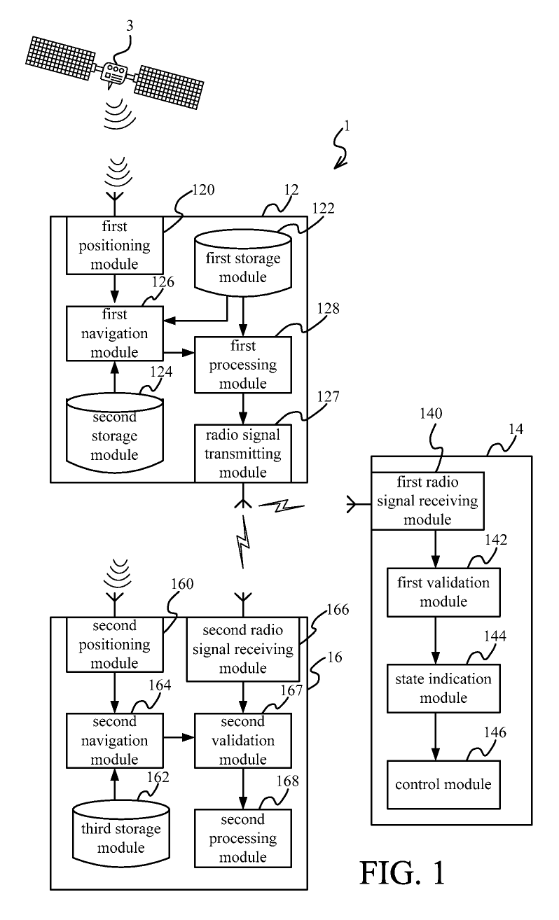

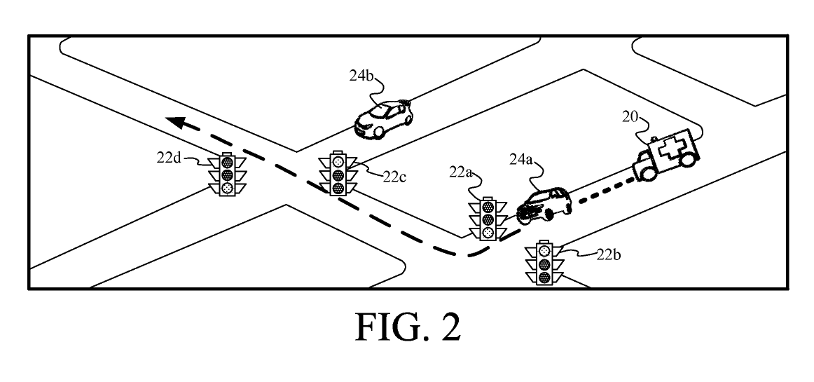

Please refer to FIG. 1 and FIG. 2. FIG. 1 is a function block diagram of a traffic control system 1 according to a preferred embodiment of the invention. FIG. 2 is a schematic diagram illustrating an environment where the traffic control system 1 according to the invention can be applied. The traffic control system 1 according to the invention includes an emergency vehicle unit 12 and a traffic signal control unit 14. In FIG. 2, an emergency vehicle 20 is equipped with the emergency vehicle unit 12 according to the invention, and each of traffic signals (22a-22d) is equipped with one traffic signal control unit 14 according to the invention.

As shown in FIG. 1 and FIG. 2, the emergency vehicle unit 12 according to the invention relates to the emergency vehicle 20, and includes a first positioning module 120, a first storage module 122, a second storage module 124, a first navigation module 126, a radio signal transmitting module 127, and a first processing module 128.

The first positioning module 120 functions periodically acquiring current location coordinates associated with the emergency vehicle 20. In one embodiment, the first positioning module 120 is configured to receive data transmitted from a global positioning system (GPS), an assisted global positioning system (AGPS), a global navigation satellite system (GLONASS), or a Galileo satellite navigation positioning system, etc. For example, the first positioning module 120 receives the data transmitted from a satellite 3 in the global positioning system, the assisted global positioning system, the global navigation satellite system, or the Galileo satellite navigation positioning system.

The first storage module 122 therein stores data associated with a plurality of traffic signals. The second storage module 124 therein stores map data. The first navigation module 126 is coupled to the first positioning module 120, the first storage module 122, and the second storage module 124, respectively. The first navigation module 126 functions generating an emergency vehicle data and determining a plurality of designated traffic signals (22a˜22d) from the plurality of traffic signals in accordance with an emergency vehicle route relating to the emergency vehicle 20, the current location coordinates associated with the emergency vehicle 20, the data associated with the traffic signals, and the map data. The first processing module 128 is coupled to the first storage module 122, the first navigation module 126, and the radio signal transmitting module 127, respectively. The first processing module 128 functions generating a preemption request signal in accordance with the emergency vehicle data and the plurality of designated traffic signals (22a˜22d), and transmitting the preemption request signal through the radio signal transmitting module 127. In one embodiment, the radio signal transmitting module 127 can be a short-range wireless signal transmitter.

In one embodiment, the preemption request signal includes an identity code relating to the emergency vehicle 20, the emergency vehicle route relating to the emergency vehicle 20, the current location coordinates associated with the emergency vehicle 20, a speed of the emergency vehicle 20, identity codes of the traffic signals been passed among the plurality of designated traffic signals, identity codes of the traffic signals not been passed yet among the plurality of designated traffic signals, state set requests for the traffic signals not been passed yet, an authorization check code, etc.

Also as shown in FIG. 1 and FIG. 2, each of the plurality of designated traffic signals (22a˜22d) is equipped with one traffic signal control unit 14 according to the invention. For explanation, an example of the traffic signal control unit 14 according to the invention and relating to the designated traffic signal 22a will be described in detail in the following. The traffic signal control unit 14 according to the invention includes a first radio signal receiving module 140, a first validation module 142, a state indication module 144, and a control module 146. The first validation module 142 is coupled to the first radio signal receiving module 140.

The first validation module 142 functions receiving the preemption request signal through the first radio signal receiving module 140, and filtering a designated data associated with the designated traffic signal 22a of the preemption request signal. The first validation module 142 judges if the designated data is valid. In one embodiment, the first radio signal receiving module 140 can be a short-range wireless signal receiver.

The state indication module 144 is coupled to the first validation module 142. If the first validation module 142 judges the designated data to be valid, the state indication module 144 receives the designated data, and selectively generates and transmits a state change request data in accordance with the designated data. The control module 146 is coupled to the state indication module 144. The control module 146 functions receiving the state change request data transmitted by the state indication module 144, and controlling the designated traffic signal 22a based on the state change request data.

Also as shown in FIG. 1 and FIG. 2, according to another preferred embodiment of the invention, the traffic control system 1 further includes an ordinary vehicle unit 16. Both of an ordinary vehicle 24a and an ordinary vehicle 24b shown in FIG. 2 are equipped with one ordinary vehicle unit 16 according to the invention. For explanation, an example of the ordinary vehicle unit 16 according to the invention and relating to the ordinary vehicle 24a will be described in detail in the following. The ordinary vehicle unit 16 according to the invention includes a second positioning module 160, a third storage module 162, a second navigation module 164, a second radio signal receiving module 166, a second validation module 167, and a second processing module 168.

The second positioning module 160 functions periodically acquiring current location coordinates associated with the ordinary vehicle 24a. In one embodiment, the second positioning module 160 is configured to receive data transmitted from the global positioning system (GPS), the assisted global positioning system (AGPS), the global navigation satellite system (GLONASS), or the Galileo satellite navigation positioning system, etc.

The third storage module 162 therein stores the map data. The second navigation module 164 is coupled to the second positioning module 160 and the third storage module 162, respectively. The second navigation module functions generating an ordinary vehicle data in accordance with an ordinary vehicle route relating to the ordinary vehicle 24a, the current location coordinates associated with the ordinary vehicle 24a, and the map data.

The second validation module 167 is coupled to the second navigation module 164 and the second radio signal receiving module 166, respectively. The second validation module 167 functions receiving the preemption request signal through the first radio signal receiving module 166, and judging if the preemption request signal is valid. In one embodiment, the second radio signal receiving module 166 can be a short-range wireless signal receiver.

If the preemption request signal is judged to be valid, the second validation module 167 also judges if the ordinary vehicle route relating to the ordinary vehicle 24a overlaps the emergency vehicle route relating to the emergency vehicle 20 in accordance with the ordinary vehicle data and the preemption request signal.

The second processing module 168 is coupled to the second validation module 167. If the second validation module 167 judges that the ordinary vehicle route relating to the ordinary vehicle 24a overlaps the emergency vehicle route relating to the emergency vehicle 20, the second processing module 168 receives the ordinary vehicle data and the preemption request signal, and selectively generates a warning signal in accordance with the ordinary vehicle data and the preemption request signal. For example, the ordinary vehicle 24a shown in FIG. 2 is equipped with the ordinary vehicle unit 16 whose second processing module 168 finally receives the ordinary vehicle data and the preemption request signal, and according to the ordinary vehicle data and the preemption request signal, judges that the ordinary vehicle 24a is in the way of the emergency vehicle 20. Hence, the second processing module 168 generates a warning signal to remind the driver of the ordinary vehicle 24a to give way the emergency vehicle 20. The ordinary vehicle 24b shown in FIG. 2 is equipped with one ordinary vehicle unit 16 whose second processing module 168 finally receives the ordinary vehicle data and the preemption request signal, and according to the ordinary vehicle data and the preemption request signal, judges that although the ordinary vehicle route relating to the ordinary vehicle 24b overlaps the emergency vehicle route relating to the emergency vehicle 20, the ordinary vehicle 24b is not in the way of the emergency vehicle 20. Hence, the second processing module 168 doesn't generate the warning signal, and the driver of the ordinary vehicle 24b keeps driving without any change.

In practical application, the ordinary vehicle unit 16 also includes a warning module (not shown in FIG. 1). The warning module is coupled to the second processing module 168. The warning module functions receiving the warning signal, and then playing a sound and/or a light triggered by the warning signal to remind the drivers to give way to the emergency vehicle 20.

In practical application, the ordinary vehicle unit 16 also can include a display module (not shown in FIG. 1). The display module is coupled to the second processing module 168. The display module functions receiving and displaying the warning signal to remind the drivers to give way to the emergency vehicle 20.

According to another preferred embodiment of the invention, the traffic control system 1 including the emergency vehicle unit 12 and the ordinary vehicle unit 16 further includes the traffic control unit 14. Constituents and operation of the emergency vehicle unit 12, the ordinary vehicle unit 16 and the traffic control unit 14 have been described in detail above, and it will not be described again.

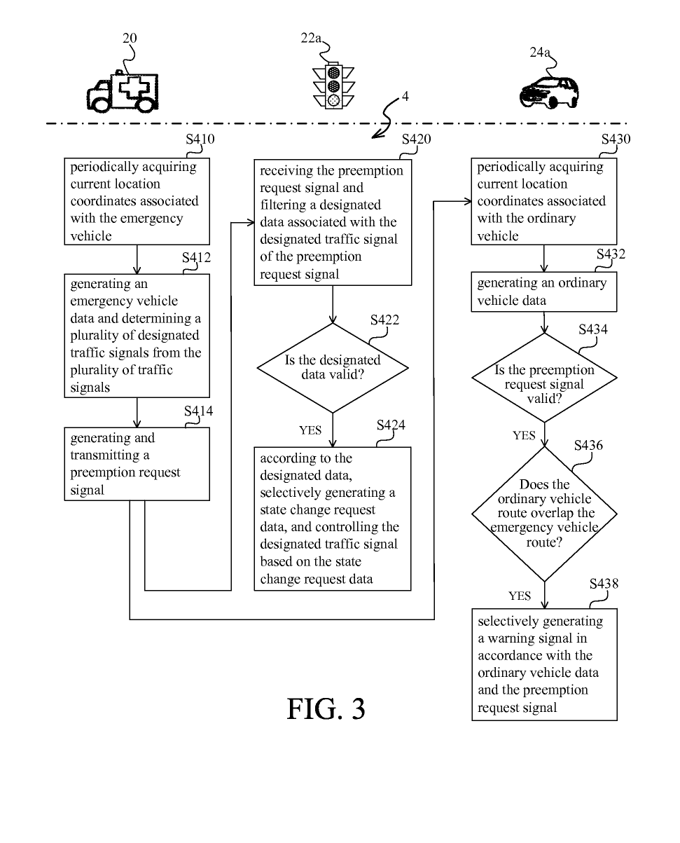

Please refer to FIG. 3 and FIG. 2, a traffic control method 4 according to a preferred embodiment of the invention, first, is at an emergency vehicle 20 to perform steps S410˜S414. Step S410 is performed to periodically acquire current location coordinates associated with the emergency vehicle 20. Step S410 is performed by receiving data transmitted from the global positioning system (GPS), the assisted global positioning system (AGPS), the global navigation satellite system (GLONASS), or the Galileo satellite navigation positioning system, etc.

Step S412 is performed to generate an emergency vehicle data and determine a plurality of designated traffic signals (22a˜22d) from a plurality of traffic signals in accordance with an emergency vehicle route relating to the emergency vehicle 20, the current location coordinates associated with the emergency vehicle 20, data associated with the traffic signals, and map data.

Step S414 is performed to generate and transmit a preemption request signal in accordance with the emergency vehicle data and the plurality of designated traffic signals.

In one embodiment, the preemption request signal includes an identity code relating to the emergency vehicle 20, the emergency vehicle route relating to the emergency vehicle 20, the current location coordinates associated with the emergency vehicle 20, a speed of the emergency vehicle 20, identity codes of the traffic signals been passed among the plurality of designated traffic signals, identity codes of the traffic signals not been passed yet among the plurality of designated traffic signals, state set requests for the traffic signals not been passed yet, and an authorization check code, etc.

Then, the traffic control method 4 according to the invention is at one designated traffic signal 22a from the plurality of designated traffic signals (22a-22d) to perform steps S420˜S424. Step S420 is performed to receive the preemption request signal, and filter a designated data associated with said one designated traffic signal 22a from the preemption request signal.

Step S422 is performed to judge if the designated data is valid.

If the designated data is judged to be valid, step S424 is performed to selectively generate a state change request data in accordance with said one designated data, and control said one designated traffic signal 22a based on the state change request data.

According to another preferred embodiment of the invention, the traffic control method 4 is further at an ordinary vehicle 24a to perform steps S430˜S438. Step S430 is performed to periodically acquire current location coordinates associated with the ordinary vehicle 24a. Step S430 is performed by receiving data transmitted from the global positioning system (GPS), the assisted global positioning system (AGPS), the global navigation satellite system (GLONASS), or the Galileo satellite navigation positioning system, etc.

Step S432 is performed to generate an ordinary vehicle data in accordance with an ordinary vehicle route relating to the ordinary vehicle 24a, the current location coordinates associated with the ordinary vehicle 24a, and the map data.

Step S434 is performed to receive the preemption request signal, and judging if the preemption request signal is valid.

If the preemption request signal is judged to be valid, step S436 is performed to judge if the ordinary vehicle route relating to the ordinary vehicle 24a overlaps the emergency vehicle route relating to the emergency vehicle 20 in accordance with the ordinary vehicle data and the preemption request signal.

If it is judged that the ordinary vehicle route relating to the ordinary vehicle 24a overlaps the emergency vehicle route relating to the emergency vehicle 20, step S438 is performed to selectively generate a warning signal in accordance with the ordinary vehicle data and the preemption request signal. The warning signal can be received by a warning module of the ordinary vehicle 24a to trigger the warning module playing a sound and/or a light to remind the driver of the ordinary vehicle 24a. The warning signal can also be received and displayed by a display module of the ordinary vehicle 24a to remind the driver of the ordinary vehicle 24a.

The traffic control method 4 according to another preferred embodiment of the invention, first, is at an emergency vehicle 20 to perform steps S410˜S414, and then at one designated traffic signal 22a to perform steps S420˜S424. All of these steps have been described in detail above, and it will not be described again.

To sum up, it can be understood clearly that the traffic control system and method according to the invention utilizes the positioning system to assist in preemption for an emergency vehicle such as ambulance, fire truck, police car, and so on. Thereby, the emergency vehicle can actively and automatically trigger the next traffic lights on the way, the emergency vehicle will pass through, to light up the green light in the most accurate time, and such that the emergency vehicle then can be allowed to quickly pass through in the minimum disruption of traffic situation. Furthermore, the emergency vehicle can notice the ordinary vehicles on the way, where the emergency vehicle will pass through, with precise position and speed of the emergency vehicle, the most accurate time when the ordinary vehicles should give way to the emergency vehicle, and other data relative to the emergency vehicle.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A traffic control system, comprising:
an emergency vehicle unit relative to an emergency vehicle, comprising:
a first positioning module, for periodically acquiring current location coordinates associated with said emergency vehicle;
a first storage module therein storing data associated with a plurality of traffic signals;
a second storage module therein storing map data;
a first navigation module, coupled to the first positioning module, the first storage module, and the second storage module, respectively, for generating an emergency vehicle data and determining a plurality of designated traffic signals from the plurality of traffic signals in accordance with an emergency vehicle route relating to the emergency vehicle, the current location coordinates associated with the emergency vehicle, the data associated with the traffic signals, and the map data;
a radio signal transmitting module;
a first processing module, coupled to the first storage module, the first navigation module, and the radio signal transmitting module, respectively, for generating a preemption request signal in accordance with the emergency vehicle data and the plurality of designated traffic signals, and transmitting the preemption request signal through the radio signal transmitting module; and
a traffic signal control unit associated with one of the designated traffic signals, comprising:
a first radio signal receiving module;
a first validation module, coupled to the first radio signal receiving module, for receiving the preemption request signal through the first radio signal receiving module, filtering a designated data associated with the designated traffic signal from the preemption request signal, and judging if the designated data is valid;
a state indication module, coupled to the first validation module, for receiving the designated data, and selectively generating and transmitting a state change request data in accordance with the designated data if the first validation module judges the designated data to be valid; and
a control module, coupled to the state indication module, for receiving the state change request data transmitted by the state indication module, and controlling the designated traffic signal based on the state change request data.

2. The traffic control system of claim 1, wherein the first positioning module is configured to receive data transmitted from one selected from the group consisting of a global positioning system (GPS), an assisted global positioning system (AGPS), a global navigation satellite system (GLONASS), and a Galileo satellite navigation positioning system.

3. The traffic control system of claim 1, wherein the preemption request signal comprises an identity code relating to the emergency vehicle, the emergency vehicle route relating to the emergency vehicle, the current location coordinates associated with the emergency vehicle, a speed of the emergency vehicle, identity codes of the traffic signals been passed among the plurality of designated traffic signals, identity codes of the traffic signals not been passed yet among the plurality of designated traffic signals, state set requests for the traffic signals not been passed yet, and an authorization check code.

4. The traffic control system of claim 1, further comprising:
an ordinary vehicle unit relating to an ordinary vehicle, comprising:
a second positioning module, for periodically acquiring current location coordinates associated with said ordinary vehicle;
a third storage module therein storing the map data;
a second navigation module, coupled to the second positioning module and the third storage module, respectively, for generating an ordinary vehicle data in accordance with an ordinary vehicle route relating to the ordinary vehicle, the current location coordinates associated with the ordinary vehicle, and the map data;
a second radio signal receiving module;
a second validation module, coupled to the second navigation module and the second radio signal receiving module, respectively, for receiving the preemption request signal through the second radio signal receiving module, judging if the preemption request signal is valid, and if YES, judging if the ordinary vehicle route relating to the ordinary vehicle overlaps the emergency vehicle route relating to the emergency vehicle in accordance with the ordinary vehicle data and the preemption request signal; and
a second processing module, coupled to the second validation module, for receiving the ordinary vehicle data and the preemption request signal, and selectively generating a warning signal in accordance with the ordinary vehicle data and the preemption request signal if the second validation module judges that the ordinary vehicle route relating to the ordinary vehicle overlaps the emergency vehicle route relating to the emergency vehicle.

5. The traffic control system of claim 4, wherein the ordinary vehicle unit also comprises a warning module, coupled to the second processing module, for receiving the warning signal, and then playing a sound and/or a light triggered by the warning signal.

6. The traffic control system of claim 4, wherein the ordinary vehicle unit also comprises a display module, coupled to the second processing module, for receiving and displaying the warning signal.

7. The traffic control system of claim 4, wherein the second positioning module is configured to receive data transmitted from one selected from the group consisting of a global positioning system (GPS), an assisted global positioning system (AGPS), a global navigation satellite system (GLONASS), and a Galileo satellite navigation positioning system.

8. A traffic control method, comprising the steps of:
(a) at an emergency vehicle, performing the steps of:
(a1) periodically acquiring current location coordinates associated with said emergency vehicle;
(a2) generating an emergency vehicle data and determining a plurality of designated traffic signals from a plurality of traffic signals in accordance with an emergency vehicle route relating to the emergency vehicle, the current location coordinates associated with the emergency vehicle, data associated with the traffic signals, and map data; and
(a3) generating and transmitting a preemption request signal in accordance with the emergency vehicle data and the plurality of designated traffic signals; and
(b) at one of the designated traffic signals from the plurality of designated traffic signals, performing the steps of:
(b1) receiving the preemption request signal, and filtering a designated data associated with said one designated traffic signal from the preemption request signal;
(b2) judging if the designated data is valid; and
(b3) if YES in step (b2), selectively generating a state change request data in accordance with said one designated data, and controlling said one designated traffic signal based on the state change request data.

9. The traffic control method of claim 8, wherein the step (a1) is performed by receiving data transmitted from one selected from the group consisting of a global positioning system (GPS), an assisted global positioning system (AGPS), a global navigation satellite system (GLONASS), and a Galileo satellite navigation positioning system.

10. The traffic control method of claim 8, wherein the preemption request signal comprises an identity code relating to the emergency vehicle, the emergency vehicle route relating to the emergency vehicle, the current location coordinates associated with the emergency vehicle, a speed of the emergency vehicle, identity codes of the traffic signals been passed among the plurality of designated traffic signals, identity codes of the traffic signals not been passed yet among the plurality of designated traffic signals, state set requests for the traffic signals not been passed yet, and an authorization check code.

11. The traffic control method of claim 8, further comprising the steps of:
(c) at an ordinary vehicle, performing the steps of:
(c1) periodically acquiring current location coordinates associated with said ordinary vehicle;
(c2) generating an ordinary vehicle data in accordance with an ordinary vehicle route relating to the ordinary vehicle, the current location coordinates associated with the ordinary vehicle, and the map data;
(c3) receiving the preemption request signal, and judging if the preemption request signal is valid;
(c4) if YES in step (c3), judging if the ordinary vehicle route relating to the ordinary vehicle overlaps the emergency vehicle route relating to the emergency vehicle in accordance with the ordinary vehicle data and the preemption request signal; and
(c5) if YES in step (c4), selectively generating a warning signal in accordance with the ordinary vehicle data and the preemption request signal.

12. The traffic control method of claim 8, wherein the ordinary vehicle unit comprises a warning module for receiving the warning signal, and then playing a sound and/or a light triggered by the warning signal.

13. The traffic control method of claim 8, wherein the ordinary vehicle unit comprises a display module for receiving and displaying the warning signal.

14. The traffic control method of claim 8, wherein the step (c1) is performed by receiving data transmitted from one selected from the group consisting of a global positioning system (GPS), an assisted global positioning system (AGPS), a global navigation satellite system (GLONASS), and a Galileo satellite navigation positioning system.

15. A traffic control system, comprising:
an emergency vehicle unit relative to an emergency vehicle, comprising:
a first positioning module, for periodically acquiring current location coordinates associated with said emergency vehicle;
a first storage module therein storing data associated with a plurality of traffic signals;
a second storage module therein storing map data;
a first navigation module, coupled to the first positioning module, the first storage module, and the second storage module, respectively, for generating an emergency vehicle data and determining a plurality of designated traffic signals from the plurality of traffic signals in accordance with an emergency vehicle route relating to the emergency vehicle, the current location coordinates associated with the emergency vehicle, the data associated with the traffic signals, and the map data;
a radio signal transmitting module;
a first processing module, coupled to the first storage module, the first navigation module, and the radio signal transmitting module, respectively, for generating a preemption request signal in accordance with the emergency vehicle data and the plurality of designated traffic signals, and transmitting the preemption request signal through the radio signal transmitting module; and
an ordinary vehicle unit relating an ordinary vehicle, comprising:
a second positioning module, for periodically acquiring current location coordinates associated with said ordinary vehicle;
a third storage module therein storing the map data;
a second navigation module, coupled to the second positioning module and the third storage module, respectively, for generating an ordinary vehicle data in accordance with an ordinary vehicle route relating to the ordinary vehicle, the current location coordinates associated with the ordinary vehicle, and the map data;
a first radio signal receiving module;
a first validation module, coupled to the second navigation module and the first radio signal receiving module, respectively, for receiving the preemption request signal through the first radio signal receiving module, judging if the preemption request signal is valid, and if YES, judging if the ordinary vehicle route relating to the ordinary vehicle overlaps the emergency vehicle route relating to the emergency vehicle in accordance with the ordinary vehicle data and the preemption request signal; and
a second processing module coupled to the first validation module, for receiving the ordinary vehicle data and the preemption request signal, and selectively generating a warning signal in accordance with the ordinary vehicle data and the preemption request signal if the first validation module judges that the ordinary vehicle route relating to the ordinary vehicle overlaps the emergency vehicle route relating to the emergency vehicle.

16. The traffic control system of claim 15, wherein the first positioning module is configured to receive data transmitted from one selected from the group consisting of a global positioning system (GPS), an assisted global positioning system (AGPS), a global navigation satellite system (GLONASS), and a Galileo satellite navigation positioning system.

17. The traffic control system of claim 15, wherein the second positioning module is configured to receive data transmitted from one selected from the group consisting of a global positioning system (GPS), an assisted global positioning system (AGPS), a global navigation satellite system (GLONASS), and a Galileo satellite navigation positioning system.

18. The traffic control system of claim 15, wherein the preemption request signal comprises an identity code relating to the emergency vehicle, the emergency vehicle route relating to the emergency vehicle, the current location coordinates associated with the emergency vehicle, a speed of the emergency vehicle, identity codes of the traffic signals been passed among the plurality of designated traffic signals, identity codes of the traffic signals not been passed yet among the plurality of designated traffic signals, state set requests for the traffic signals not been passed yet, and an authorization check code.

19. The traffic control system of claim 15, wherein the ordinary vehicle unit also comprises a warning module, coupled to the second processing module, for receiving the warning signal and then playing a sound and/or a light triggered by the warning signal.

20. The traffic control system of claim 15, wherein the ordinary vehicle unit also comprises a display module, coupled to the second processing module, for receiving and displaying the warning signal.

21. The traffic control system of claim 15, further comprising:
a traffic signal control unit associated with one of the designated traffic signals, comprising:
a second radio signal receiving module;
a second validation module, coupled to the second radio signal receiving module, for receiving the preemption request signal through the second radio signal receiving module, filtering a designated data associated with the designated traffic signal from the preemption request signal, and judging if the designated data is valid;
a state indication module, coupled to the second validation module, for receiving the designated data, and selectively generating and transmitting a state change request data in accordance with the designated data if the second validation module judges the designated data to be valid; and
a control module, coupled to the state indication module, for receiving the state change request data transmitted by the state indication module, and controlling the designated traffic signal based on the state change request data.

22. A traffic control method, comprising the steps of:
(a) at an emergency vehicle, performing the steps of:
(a1) periodically acquiring current location coordinates associated with said emergency vehicle;
(a2) generating an emergency vehicle data and determining a plurality of designated traffic signals from a plurality of traffic signals in accordance with an emergency vehicle route relating to the emergency vehicle, the current location coordinates associated with the emergency vehicle, data associated with the traffic signals, and map data; and
(a3) generating and transmitting a preemption request signal in accordance with the emergency vehicle data and the plurality of designated traffic signals; and
(b) at an ordinary vehicle, performing the steps of:
(b1) periodically acquiring current location coordinates associated with said ordinary vehicle;
(b2) generating an acquiring ordinary vehicle data in accordance with an ordinary vehicle route relating to the ordinary vehicle, the current location coordinates associated with the ordinary vehicle, and the map data;
(b3) receiving the preemption request signal, and judging if the preemption request signal is valid;
(b4) if YES in step (b3), judging if the ordinary vehicle route relating to the ordinary vehicle overlaps the emergency vehicle route relating to the emergency vehicle in accordance with the ordinary vehicle data and the preemption request signal; and
(b5) if YES in step (b4), selectively generating a warning signal in accordance with the ordinary vehicle data and the preemption request signal.

23. The traffic control method of claim 22, wherein the step (a1) is performed by receiving data transmitted from one selected from the group consisting of a global positioning system (GPS), an assisted global positioning system (AGPS), a global navigation satellite system (GLONASS), and a Galileo satellite navigation positioning system.

24. The traffic control method of claim 22, wherein the step (b1) is performed by receiving data transmitted from one selected from the group consisting of a global positioning system (GPS), an assisted global positioning system (AGPS), a global navigation satellite system (GLONASS), and a Galileo satellite navigation positioning system.

25. The traffic control method of claim 22, wherein the preemption request signal comprises an identity code relating to the emergency vehicle, the emergency vehicle route relating to the emergency vehicle, the current location coordinates associated with the emergency vehicle, a speed of the emergency vehicle, identity codes of the traffic signals been passed among the plurality of designated traffic signals, identity codes of the traffic signals not been passed yet among the plurality of designated traffic signals, state set requests for the traffic signals not been passed yet, and an authorization check code.

26. The traffic control method of claim 22, wherein the ordinary vehicle unit also comprises a warning module for receiving the warning signal and then playing a sound and/or a light triggered by the warning signal.

27. The traffic control method of claim 22, wherein the ordinary vehicle unit also comprises a display module for receiving and displaying the warning signal.

28. The traffic control method of claim 22 further comprises:
(c) at one of the designated traffic signals from the plurality of designated traffic signals, performing the steps of:
(c1) receiving the preemption request signal, and filtering a designated data associated with said one designated traffic signal of the preemption request signal;
(c2) judging if the designated data is valid; and
(c3) if YES in step (2), selectively generating a state change request data in accordance with said one designated data, and controlling said one designated traffic signal based on the state change request data.
